(19) United States
(12) Patent Application Publication
(10) Pub. No.: US 2012/0038926 A1
(43) Pub. Date: Feb. 16, 2012

(54) OPTICAL SENSOR, METHOD FOR MANUFACTURING SAME AND DETECTION METHOD USING OPTICAL SENSOR

(76) Inventors: Tatsuro Endo, Osaka (JP); Yoshiaki Takaya, Chiba (JP); Satoru Tanaka, Tokyo (JP)

(21) Appl. No.: 13/126,343

(22) PCT Filed: Oct. 16, 2009
(86) PCT No.: PCT/JP2009/005415

§ 371 Date: Oct. 26, 2011

(30) Foreign Application Priority Data
Oct. 17, 2008 (JP) 2008-269231

(51) Int. Cl. G01N 21/55; B23P 17/00

(52) U.S. Cl. 356/445; 29/527.5

(57) ABSTRACT

A highly sensitive and reliable optical sensor which has a low production cost, and facilitates a detection is provided. An optical sensor 1 that detects a predetermined detection target includes a concavo-convex structure 2 which has a predetermined form periodically arranged in a two-dimensional manner and which functions as a photonic crystal, a metal layer 3 which is formed on a surface of the concavo-convex structure 2 and which is capable of exciting localized surface plasmon resonance, and an adsorption element which is formed on the surface of the metal layer 3 and adsorbs the detection target. The detection target is detected based on optical characteristics before and after the detection target is adsorbed on the optical sensor 1.

### TECHNICAL FIELD

The present invention relates to an optical sensor which is high sensitive and which is easy to operate.

### BACKGROUND ART

For detection of a detection target and quantification thereof using a high recognition capability of biological molecules, such as enzyme, an antibody, and a DNA, conventionally, a PCR (Polymerase Chain reaction) method, an electrochemical measurement method, and an ELISA (Enzyme-linked immunosorbent assay) method are mainly applied.

The electrochemical measurement method immobilizes the biological molecules that specifically recognize a detection target on an electrode surface as a recognition element, and detects an electrochemical change in a signal caused when the detection target is combined with the recognition element or detects an amplification of the signal by a labeled substance like enzyme, thereby performing quantification.

Moreover, the ELISA method detects a coloring or a fluorescence depending on an enzyme reaction by enzyme labeled beforehand after a combination of a biological molecule and a detection target or on the concentration of the detection target by fluorescent molecules.

According to the electrochemical method or the ELISA method, however, a labeling agent, such as enzyme or a fluorescent substance, is necessary for the detection target or the biological molecules that are used as the recognition element. Conventionally, the labeling work interferes with the recognition capability of the biological molecules having the high recognition capability, and reduces the sensitivity and makes the operation complex because of the necessity of the labeling work. Moreover, when a detection target is highly sensitively detected and quantified, an expensive and large measuring apparatus is needed.

Furthermore, there is an immune chromatography that is getting an attention as a simple measurement method, but in this case, a modifier, such as gold colloid or polystyrene grain is necessary.

Because of such a circumstance, there is a desire for a measurement method which can detect and quantify a detection target without labeling (non-labeling) biological molecules with enzyme, fluorescent molecules, etc.

Hence, there are developed a surface Plasmon resonance (SPR) method which detects a shift in a resonance angle and which can detect and quantify a detection target without labeling, a quartz crystal microbalance (QCM) method that detects a change in the number of vibrations or a detection target detecting-quantifying method through a cantilever that detects a change in the resonance frequency without labeling.

According to the SPR method, however, it is necessary to build a large optical system in order to detect a resonance angle shift, and the successive operations are complex. Hence, it is not appropriate for monitoring of a detection target in an on-site manner. Moreover, according to the QCM method, measurement is simple but noises are large and this method is not appropriate for a high sensitive measurement. Furthermore, the cantilever method has an extreme difficulty in manufacturing of a device, and is not appropriate for a simple measurement.

Moreover, in addition to the above-explained methods, there are known a measurement method (see, for example, Patent Literature 1) of utilizing localized surface plasmon resonance (LSPR) that is a nonlinear optical phenomenon developed by noble metal fine particles like gold, silver, or platinum in a nano meter order, and a measurement method (see, for example, Patent Literature 2) of using a sensor that serves as a photonic crystal having particles arranged in a three-dimensional manner.

According to those methods, however, it is extremely difficult to uniformly arrange the fine particles, and the reproducibility is quite low, so that there is a problem from the standpoint of the sensitivity and the reliability.

Moreover, conventional sensors have a low reproducibility among the sensors, so that it is possible to compare the difference in the optical characteristic before and after a sample is caused to contact using the same sensor, but it is difficult to utilize a change in the optical characteristic when the concentration, etc., of a detection target contained in the sample is changed and to construct a database of such a change using the plurality of sensors.

Furthermore, the yield of the sensor and the throughput thereof are low, which need a cost.

Patent Literature 1: JP 2006-250668 A

Patent Literature 2: JP 2007-271609 A

### DISCLOSURE OF INVENTION

### Problem to be Solved by the Invention

Accordingly, it is an object of the present invention to provide a highly sensitive and reliable optical sensor which has a low production cost, and facilitates a detection.

### Means for Solving the Problem

The present invention provides an optical sensor which detects a predetermined detection target and includes: a concavo-convex structure which has a predetermined form periodically arranged in a two-dimensional manner and which functions as a photonic crystal; and a metal layer which is formed on a surface of the concavo-convex structure and which is capable of exciting localized surface plasmon resonance.

In this case, it is preferable that a difference between a peak wavelength of light reflected by the concavo-convex structure and a peak wavelength of light absorbed by the metal layer should be equal to or smaller than 10 nm. Moreover, it is preferable that the concavo-convex structure should include columns or holes each having a certain diameter within a range from 50 to 500 nm and periodically arranged at a certain pitch within a range from 50 to 1000 nm in a two-dimensional manner. It is preferable that a film thickness of the metal layer should be 5 to 200 nm. It is preferable that the metal layer should include an adsorption element that adsorbs the detection target on a surface thereof. Furthermore, the concavo-convex structure can be appropriately formed of any one of a cyclic-olefin-based resin, an acrylic resin, polycarbonate, a vinyl-ether resin, a fluorine resin, and a polyester-based resin.

The present invention provides another optical sensor which detects a predetermined detection target and includes: a concavo-convex structure which includes a predetermined form periodically arranged in a two-dimensional manner and which functions as a photonic crystal, in which the concavo-convex structure is formed of any one of resins selected from a following group: a cyclic-olefin-based resin; an acrylic resin; polycarbonate; a vinyl-ether resin; a fluorine resin; and a polyester-based resin.

It is preferable that the concavo-convex structure of the above-explained optical sensor should be formed by imprinting. Moreover, the concavo-convex structure and the metal layer may be formed of a material dissolved or decomposed by the detection target. Furthermore, it is preferable that the concavo-convex structure should include an adsorption element that adsorbs the detection target on a surface thereof.

The present invention provides a method for manufacturing an optical sensor that detects a predetermined detection target, the method includes: a concavo-convex structure forming step of forming a concavo-convex structure which has a predetermined form periodically arranged in a two-dimensional manner and which functions as a photonic crystal; and a metal layer forming step of forming a metal layer on a surface of the concavo-convex structure, the metal layer being capable of exciting localized surface plasmon resonance.

In this case, it is preferable that, in the concavo-convex structure forming step, the concavo-convex structure should be formed by imprinting. Moreover, it is preferable that, in the metal layer forming step, the metal layer should be formed by any one of physical vapor deposition (PVD), chemical vapor deposition (CVD), and plating.

The present invention provides a detection method for detecting a detection target contained in a sample solution, the method includes: preparing an optical sensor which includes a concavo-convex structure that functions as a photonic crystal and a metal layer formed on a surface of the concavo-convex structure and being capable of exciting localized surface plasmon resonance, the optical sensor having a difference of equal to or smaller than 10 nm between a peak wavelength of light reflected by the concavo-convex structure and a peak wavelength of light absorbed by the metal layer; and comparing a characteristic of light reflected by the optical sensor with a characteristic of light reflected by the optical sensor after the sample is caused to contact the concavo-convex structure, thereby detecting the detection target contained in the sample solution.

The present invention provides another detection method for detecting a detection target contained in a sample solution, the method includes: preparing an optical sensor which includes a concavo-convex structure that functions as a photonic crystal and a metal layer formed on a surface of the concavo-convex structure and being capable of exciting localized surface plasmon resonance, the optical sensor having a difference of equal to or smaller than 10 nm between a peak wavelength of light reflected by the concavo-convex structure and a peak wavelength of light absorbed by the metal layer; preparing a database built by causing samples containing the detection target with various concentrations to contact the optical sensor, and by detecting respective characteristics of light reflected by the optical sensor; and comparing a characteristic of light reflected by the optical sensor after the sample solution is caused to contact the concavo-convex structure with information stored in the database, thereby detecting the detection target contained in the sample solution.

### Effect of the Invention

There is provided a highly sensitive and reliable optical sensor which compositely has a function as a photonic crystal and a function by a localized surface plasmon resonance.

Moreover, since the optical sensor having a concavo-convex structure precisely formed with regularity is manufactured through a nano imprinting technique, a highly sensitive and reliable optical sensor can be manufactured at a low cost and can be in mass production. Accordingly, a comparison of optical characteristics between different optical sensors is enabled, and by building a database of the comparison result, a further simple detection method is provided.

### BRIEF DESCRIPTION OF DRAWINGS

FIG. 1 is a diagram for explaining a measurement method by an optical sensor of the present invention;

FIG. 2A is a diagram for explaining a manufacturing method of the optical sensor of the present invention;

FIG. 2B is a diagram for explaining a manufacturing method of the optical sensor of the present invention;

FIG. 2C is a diagram for explaining a manufacturing method of the optical sensor of the present invention;

FIG. 2D is a diagram for explaining a manufacturing method of the optical sensor of the present invention;

FIG. 3 is a diagram for explaining a measurement method by the optical sensor of the present invention;

FIG. 4 is a diagram showing an optical characteristic of an optical sensor A;

FIG. 5 is a diagram showing a change in a peak wavelength of reflected light relative to the concentration of protein according to the optical sensor A;

FIG. 6 is a diagram showing a change in an intensity of light relative to the concentration of protein according to the optical sensor A;

FIG. 7 is a diagram showing an optical characteristic of an optical sensor B of the present invention;

FIG. 8 is a diagram showing an optical characteristic of an optical sensor C of the present invention;

FIG. 9 is a diagram showing an optical characteristic of an optical sensor D of the present invention;

FIG. 10 is a diagram for explaining a measurement method by the optical sensor of the present invention; and

FIG. 11 is a diagram for explaining a measurement method by the optical sensor of the present invention.

### DESCRIPTION OF REFERENCE NUMERALS

1 Optical sensor

2 Concavo-convex structure

3 Metal layer

21 Light

22 Reflected light

23 Transmitted light

30 Light source

40 Light detecting unit

50 Information processing unit

### BEST MODE FOR CARRYING OUT THE INVENTION

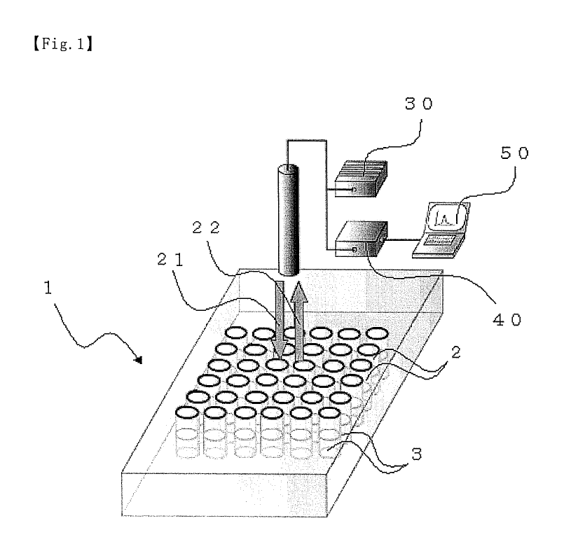

As shown in FIG. 1, an optical sensor 1 of the present invention is for detecting a predetermined detection target, and mainly includes a concavo-convex structure 2 which has a predetermined form periodically arranged in a two-dimensional manner and which serves as a photonic crystal and a metal layer 3 which is formed on the surface of the concavo-convex structure 2 and which is capable of exciting localized surface plasmon resonance.

The concavo-convex structure 2 is not limited to any particular one as long as it can serve as a photonic crystal, but a structure can be employed which has holes (see FIG. 1) or cylinders (see FIG. 10) with a predetermined diameter and periodically arranged in a two-dimensional manner at a predetermined pitch. Moreover, it is preferable that the pitch of the concavo-convex structure 2 should be formed so that the peak wavelength of reflected light is in a visible range. More specifically, a structure can be employed which has holes or cylinders with a diameter of 50 to 500 nm periodically arranged in a two-dimensional manner at a pitch of 50 to 1000 nm.

The material of the concavo-convex structure 2 is not limited to any particular one as long as it can form a photonic crystal, but a material to which an imprinting technique (thermal imprinting, optical imprinting, etc.,) that can produce a concavo-convex structure uniformly with a large area and with good reproducibility is applicable is preferable. For example, thermoplastic resins can be used which includes cyclic-olefin-based resins, such as cyclic olefin ring-opening polymerization/hydrogen additive (COP) and cyclic olefin copolymer (COC), acrylic resins, polycarbonate, vinyl-ether resins, fluorine resins, such as perfluoro-alkoxy-alkane (PFA) and polytetrafluoroethylene (PTFE), polystyrene, polyimide resins, and polyester-based resins. Moreover, resins which can be produced by the polymerization reaction (thermal curing or optical curing) of polymerization reactivity group containing compounds can be used which include epoxide containing compounds, (metha)acrylic acid ester compounds, and unsaturated hydrocarbon group, e.g., vinyl group and ally group containing compounds, such as vinyl-ether compounds, and bis-allylnadic imide compounds. It is possible to use the polymerization reactivity group containing compounds in solo in order to accomplish thermal polymerization, and a thermal-reactive initiator can be added and used in order to improve the thermo curing characteristic. Furthermore, polymerization reaction may be promoted by adding a photoreactive initiator and by irradiating the material with light, and the concavo-convex structure 2 may be thus formed. Example of a radical initiator with a thermal reactivity are organic peroxide, and azo compounds, and examples of a radical initiator with a photo reactivity are acetophenone derivative, benzophenone derivative, benzoin ether derivative, and xanthone derivative. Reactive monomers may be used without a solvent, or may be dissolved in a solvent and may be desolvated after coating. A substrate where the resin is applied can be arbitrarily selected as long as it does not deteriorate a target sensor sensitivity, and a transparent substrate, such as a transparent plastic substrate formed of cyclic-olefin-based resin, acrylic-based resin, or PET, a silica substrate, a sapphire substrate is particularly preferable.

From the standpoint of the dimensional stability of the pattern, it is preferable that the water absorption rate of the resin should be equal to or lower than 3%.

Moreover, it is preferable that a resin for thermal imprinting should have a heat-generation start temperature (oxidization start temperature) of a heat-generation peak together with oxidization equal to or higher than +35° C. of the glass transition temperature of the resin in a differential scanning calorimetry at a temperature-rise speed of 5° C./min under an atmospheric condition. This is because in a microfabrication by thermal imprinting, particle-like materials produced by deterioration of the resin on the resin surface can be suppressed, and the transfer failure of the concavo-convex structure 2 and the demolding failure, etc., can be dramatically reduced.

In this case, it is appropriate if the resin for thermal imprinting is a cyclic-olefin-based resin and more preferably, the resin for thermal imprinting includes at least one repeating unit represented by a formula (1).

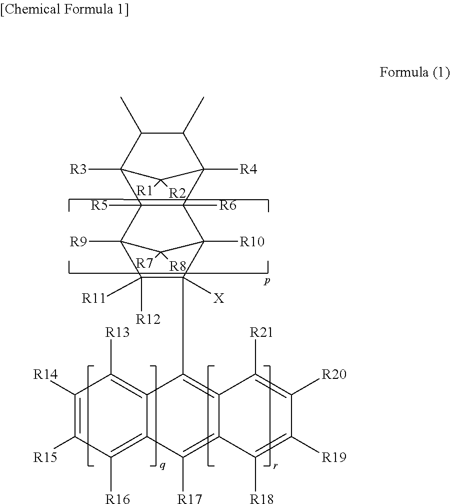

(In the formula (1), X is a halogen atom or a hydrocarbon group with a carbon number of 1 to 12. X and R21 (or R20) may be bonded together through an alkylene group. p, q, and r are 0, 1, or 2. R1 to R21 are independently a hydrogen atom, a halogen atom, an aliphatic hydrocarbon group, and an alicyclic hydrocarbon group. Moreover, R11 (or R12) and R13 (or R14) may be bonded together through an alkylene group with a carbon number of 1 to 5, or may be directly bonded together without any group. However, when R11 (or R12) and R13 (or R14) are directly bonded together without any group, R11 (or R12) that is a residue not bonded is a halogen atom or a hydrocarbon group with a carbon number of 1 to 12, and R13 (or R14) is a hydrogen atom, a halogen atom, an aliphatic hydrocarbon group, or an alicyclic hydrocarbon group)

By forming the concavo-convex structure 2 in this fashion, when the concavo-convex structure 2 is irradiated with light, because of the function as a photonic crystal, light with a specific wavelength in accordance with the concavo-convex structure 2 is reflected. Moreover, when any substance sticks to the concavo-convex structure 2, and the concavo-convex structure 2 minutely changes, the wavelength of the reflected light and the intensity thereof also change. Accordingly, based on such a change, it is possible to detect a predetermined detection target.

It is appropriate if the concavo-convex structure 2 is formed of a material dissolved or decomposed depending on a detection target. For example, when the detection target is a polar solvent, the concavo-convex structure 2 may be formed of a polar substance that can be dissolved by this polar solvent, and when the detection target is a non-polar solvent, the concavo-convex structure may be formed of a non-polar substance that can be dissolved in the non-polar solvent.

The optical sensor 1 formed as explained above has the concavo-convex structure 2 which is dissolved or decomposed when a detection target contacts the concavo-convex structure, but also in this case, the concavo-convex structure 2 produces a change, and the wavelength of reflected light and the intensity thereof also change. Hence, it is possible to detect a predetermined detection target based on such a change.

The metal layer 3 is for exciting a localized surface plasmon resonance, and for example, is formed in a localized state on the above-explained concavo-convex structure 2. When, for example, the concavo-convex structure 2 is a hole structure, it is appropriate if the meal layer 3 is formed on at least a bottom face of the hole (see FIG. 1), and when it is a column, it is appropriate that the metal layer 3 is formed on the upper surface of the column (see FIG. 10).

Any metal can be used as the metal layer 3 as long as it can excite localized surface plasmon resonance, and examples of such a metal are gold, silver, copper, platinum, and aluminum. A single kind of such metals or a combination thereof may be used. Moreover, in consideration of the joining characteristic with the material used for the concavo-convex structure 2, an interlayer like chrome may be provided.

The film thickness of the metal layer 3 is optional but it is preferable that the film thickness should be 5 to 200 nm in consideration of the sensitivity.

By forming the metal layer 3 in this fashion, when the metal layer 3 is irradiated with light, light with a specific wavelength is absorbed because of localized surface plasmon resonance. Moreover, when any substance sticks on the metal layer 3 and the metal layer 3 produces a minute change, the wavelength of absorption light and the intensity thereof also change. Hence, it is possible to detect a predetermined detection target based on such a change.

It is fine if the concavo-convex structure 2 and the metal layer 3 are formed of a material dissolved or decomposed depending on a detection target. For example, when the detection target is a polar solvent, the concavo-convex structure 2 may be formed of a polar substance that can be dissolved by this polar solvent, and when the detection target is a non-polar solvent, the concavo-convex structure may be formed of a non-polar substance that can be dissolved by the non-polar solvent.

The optical sensor 1 formed as explained above has the concavo-convex structure 2 which is dissolved or decomposed when a detection target contacts the concavo-convex structure, but also in this case, the concavo-convex structure 2 and the metal layer 3 produce a change, and the wavelength of reflected light and transmitted light and the intensity thereof also change. Hence, it is possible to detect a predetermined detection target based on such a change.

As explained above, by forming the optical sensor 1 that has the concavo-convex structure 2 which serves as a photonic crystal and the metal layer 3 which can excite localized surface plasmon resonance, double detection of a detection target is enabled based on the two optical characteristics, and the detection precision of the detection target is improved.

Moreover, a difference between the peak wavelength of light reflected by the concavo-convex structure 2 and the peak wavelength of light absorbed by the metal layer 3 can be made small as much as possible. This is because if formation is made thus way, a change in reflected light by the concavo-convex structure 2 that is a photonic crystal and a change in absorbed light by the metal layer 3 because of localized surface plasmon resonance overlap, so that when a detection target sticks on the metal layer 3 on the concavo-convex structure 2, a change in light reflected by the optical sensor 1 and a change in light absorbed by the optical sensor 1 become large before and after the sticking of the detection target, thereby improving the sensitivity of the optical sensor 1.

The principle formula of a two-dimensional photonic crystal can be expressed as follows based on the Bragg equation where:
λ: the wavelength of reflected light;
d: the distance between holes;

θ: the incident angle of light;

nₐ: an average refractive index;

f: an area occupancy of a hole;

nₕₒₗₑ: the refractive index of a hole; and

n_{medium}: the refractive index of a medium around a hole.

$$\begin{matrix}[ Formula 1 ] & \\ λ = 2 {( \frac{2}{3} )}^{\frac{1}{2}} {d ( {n}_{a}^{2} - {sin}^{2} θ )}^{\frac{1}{2}} & Formula ( 1 ) \\ [ Formula 2 ] & \\ {n}_{a} = \sqrt{{n}_{hole}^{2} f + {n}_{medium}^{2} ( 1 - f )} & Formula ( 2 )\end{matrix}$$

Moreover, a polarizability a in localized surface plasmon resonance can be expressed as follow based on the Maxwell's equations where:

rₘ: the radius of the metal layer;

εₘ(ω): the dielectric constant of the metal layer; and

ε₁: a medium around the metal layer.

$$\begin{matrix}[ Formula 3 ] & \\ α = 4 π {r}_{m}^{3} \frac{{ɛ}_{m} ( ω ) - {ɛ}_{1}}{{ɛ}_{m} ( ω ) - 2 {ɛ}_{1}} & Formula ( 3 )\end{matrix}$$

In the formula (3), the divergent condition is satisfied when the denominator of the polarizability becomes 0, and at this time, a resonance phenomenon occurs. The resonance frequency of localized surface plasmon resonance that occurs at the metal layer sufficiently smaller than the wavelength of incident light is set based on the dielectric constant εₘ(ω) of the metal layer and the medium ε₁ around the metal layer. When the size of the metal layer is not ignorable in comparison with the wavelength of the incident light, the resonance frequency can be derived based on the Mie scattering theory, but in practice, it also depends on the diameter of the metal layer and the shape thereof.

From the formula (3), localized surface plasmon resonance can be developed by a solo metal layer only, so that excitation of localized surface plasmon resonance is affected only by the size of the metal layer, i.e., the diameter of the pillar.

Accordingly, in order to make the difference small as much as possible between the peak wavelength of light reflected by the concavo-convex structure 2 and the peak wavelength of light absorbed by the metal layer 3, first, the size of the metal layer 3 is decided in order to fix the peak wavelength of absorbed light by localized surface plasmon resonance, and the distance between holes and the average refractive index are controlled so that the peak wavelength of the absorbed light matches the peak wavelength of reflected light by the photonic crystal.

It is preferable that the difference between the peak wavelength of light reflected by the concavo-convex structure 2 and the peak wavelength of light absorbed by the metal layer 3 should be equal to or smaller than 10 nm, and more preferably, equal to or smaller than 5 nm, depending on the performance of a light receiving means which receives reflected light and absorbed light.

It is fine if an adsorption element that specifically adsorbs a detection target is formed on a surface or both surfaces of the above-explained concavo-convex structure 2 and the metal layer 3. A material of the adsorption element is not limited to any particular one as long as it can be specifically bonded with the detection target and can be fixed on the concavo-convex structure 2 and the metal layer 3. For example, a material can be used which is an antibody for an antigen, an antigen for an antibody, an anti-hapten antibody for hapten, hapten for anti-hapten antibody, a hybridizable DNA or PNA for a DNA, avidin or streptavidin for biotin, biotin or biotinated protein for avidin or streptavidin, hormone(e.g., insulin) for hormone receptor (e.g., insulin receptor), hormone receptor (e.g., insulin receptor) for hormone (e.g., insulin), a corresponding sugar chain for lectin, and lectin for a corresponding sugar chain. Moreover, the adsorption element includes fragments or subunits which have a specific bonding ability. Furthermore, a cell itself can be used as the adsorption element, and in this case, the detection target can be one which specifically recognizes a portion (e.g., a receptor) of the cell.

The detection target is one which can be adsorbed by at least any one of the concavo-convex structure 2, the metal layer 3, and the adsorption element, or one which can dissolve or decompose either one of the concavo-convex structure 2 or the metal layer 3, and examples of such are a chemical substance and a biological substance. More specifically, examples of such are an antibody, an antigen, a receptor, a ligand, lectin, a sugar chain compound, an RNA, a DNA, a PNA, and hapten. When it is classified from the standpoint of the function of the detection target, hormone, immune globulin, a clotting factor, enzyme, and a medical agent are included. Example substance names are blood albumin, macroglobulin, ferritin, α-fetoprotein, CEA, prostate specific antigen (PSA), hepatitis B virus surface antigen (HBsAg), and HIV-1P24.

The optical sensor of the present invention is superior to conventional sensors in a point that it can be formed of a material and a shape to which a nano-imprinting technique can be easily applied even if it has only a photonic crystal without a metal layer 3.

This is because the nano-imprinting technique can precisely and easily form a minute structure at a low production cost, and is able to provide a sensor which is extremely highly sensitive and reliable. Moreover, conventional optical sensors have a poor reproducibility, and include a large error among the optical sensors produced, so that it is difficult to compare the optical characteristics among the different optical sensors. However, the same optical sensor formed through the nano-imprinting technique can be mass-produced with a good reproducibility, and thus the optical characteristic can be compared among different optical sensors. Accordingly, there is an advantage that by constructing a database of a change in the optical characteristic originating from the concentration of the detection target, a simper detection can be realized. Furthermore, there is a purpose as an intermediate body for producing the optical sensor 1 provided with the metal layer 3.

Next, a manufacturing method of the optical sensor of the present invention will be explained.

The optical sensor manufacturing method of the present invention mainly includes a concavo-convex structure forming step of forming the concavo-convex structure 2 which has a predetermined form periodically arranged in a two-dimensional manner and which serves as a photonic crystal, and a metal layer forming step of forming the metal layer 3 on the surface of the concavo-convex structure 2 which can excite localized surface plasmon resonance.

The concavo-convex structure forming step is not limited to any particular technique as long as a concavo-convex structure having a predetermined form precisely and periodically arranged in a two-dimensional manner and serving as a photonic crystal can be formed, but it is preferable to apply an imprinting technique.

When a thermal imprinting technique is applied, first, a film or a substrate, etc., formed of a thermoplastic resin 9 is prepared, and is shaped in a desired pattern.

Examples of such thermoplastic resin are a cyclic-olefin-based resin, such as cyclic olefin polymer and cyclic olefin copolymer (COC), an acrylic resin, polycarbonate, a vinyl-ether resin, fluorine resins, such as perfluoro-alkoxy-alkane (PFA) and polytetrafluoroethylene (PTFE) and polyester-based resins.

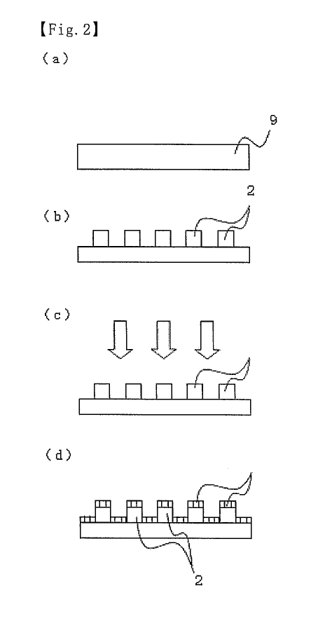

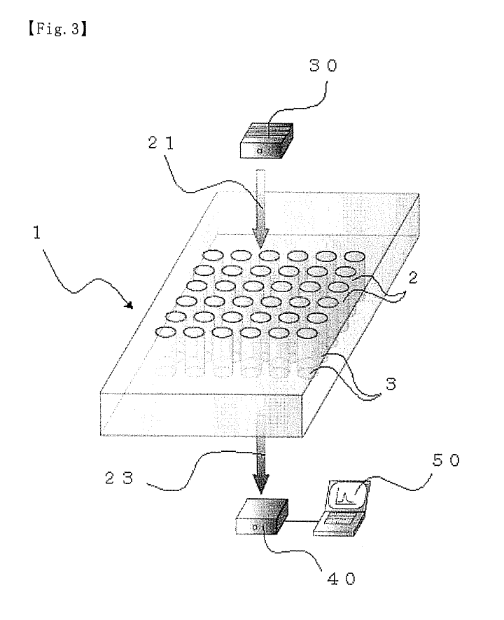

Regarding how to form the concavo-convex structure 2, first, a die 10 formed of a metal like nickel, ceramics, a carbon material like glass carbon, or a silicon is heated to a temperature equal to or higher than the glass transition temperature of the thermoplastic resin 9, and is pressed against the film or the substrate formed of the thermoplastic resin (see FIG. 2A). Next, the thermoplastic resin is cooled to a temperature equal to or lower than the glass transition temperature, and is demolded. Accordingly, a pattern 10a (the inverted pattern of the concavo-convex structure 2) formed on the die is transferred (see FIG. 2B).

How to form the concavo-convex structure 2 is not limited to the above-explained technique, and such a structure can be formed by applying a semiconductor microfabrication technique, etc.

The metal layer forming step is not limited to any particular technique as long as it can form a metal that is capable of exciting localized surface plasmon resonance on the concavo-convex structure 2 in a localized manner, but for example, the metal layer can be formed by depositing a metal on the concavo-convex structure 2 through Physical Vapor Deposition (PVD) (see FIG. 2C). Moreover, it can be formed through a Chemical Vapor Deposition (CVD) or plating like electroless plating. At this time, the film thickness of the metal layer 3 is optional, but is preferably from 5 to 200 nm in consideration of the sensitivity.

It is not illustrated in the figure but when an adsorption element is formed on the concavo-convex structure 2 or the metal layer 3, it can be formed through physical adsorption by a hydrophobic mutual action or through chemical bonding to the metal layer 3 by a chemical (this is referred to as an adsorption element forming step).

In order to facilitate handling of the optical sensor, the sensor may be a chip in a casing or a frame built in a shape that does not deteriorate the sensor performance.

Next, an explanation will be given of how to use (a detection method) the optical sensor of the present invention below.

(1) First, the optical sensor 1 that adsorbs no detection target, etc., is irradiated with light 21 in order to obtain information on the optical characteristic of reflected light 22, in particular, the peak wavelength of the reflected light and the intensity thereof (see FIG. 1 or 10). A light source 30 is not limited to any particular one, but for example, a tungsten-halogen light source, an LED, a deuterium lamp, an organic EL, or a laser can be used. Moreover, light detecting means 40 for detecting reflected light, for example, a multi-channel spectroscope, a CCD image sensor, or a CMOS sensor can be used. Furthermore, information processing means 50 like a computer can be used for processing the obtained information.

(2) Next, a sample containing the detection target is caused to contact the concavo-convex structure 2 of the optical sensor 1 of the present invention, and information on the optical characteristic of the reflected light 22 is likewise obtained.

(3) Finally, the optical characteristic of light reflected by the optical sensor is compared with the optical characteristic of light reflected by the optical sensor after the sample is caused to contact the concavo-convex structure 2, thereby detecting presence/absence of the detection target contained in a solution and the amount thereof.

The optical characteristic of reflected light when the concentration, etc., of the detection target contained in the sample beforehand is changed may be detected by the optical sensor 1, a database of detection results may be built, and the data thereof may be compared with the optical characteristic of light reflected by the optical sensor after the sample is caused to contact the concavo-convex structure 2, thereby detecting presence/absence of the detection target contained in the solution and the amount thereof. In this case, the procedure (1) becomes unnecessary.

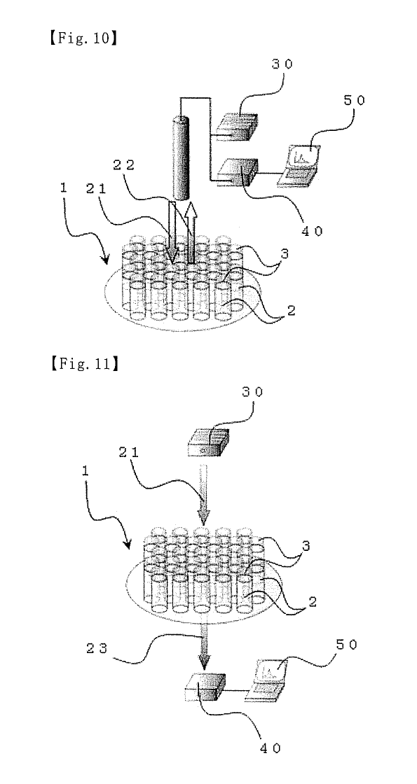

Moreover, the optical sensor 1 may be irradiated with light, and information relating to the optical characteristic of transmitted light 23 may be utilized (see FIG. 3 or 11). In this case, the optical sensor can be used as follows.

(1) First, the optical sensor 1 that adsorbs no detection target, etc., is irradiated with light 21 in order to obtain information on the optical characteristic of the transmitted light 23, in particular, the peak wavelength of the transmitted light 23 and the intensity thereof.

(2) Next, a sample containing the detection target is caused to contact the concavo-convex structure 2 of the optical sensor 1 of the present invention, and information on the optical characteristic of the transmitted light 23 is likewise obtained.

(3) Finally, the optical characteristic of light going through the optical sensor is compared with the optical characteristic of light going through the optical sensor after the sample is caused to contact the concavo-convex structure 2, thereby detecting presence/absence of the detection target contained in a solution and the amount thereof.

In this case, also, the optical characteristic of transmitted light when the concentration, etc., of the detection target contained in the sample beforehand is changed may be detected by the optical sensor 1, a database of detection results may be built, and the data thereof may be compared with the optical characteristic of light going through the optical sensor after the sample is caused to contact the concavo-convex structure 2, thereby detecting presence/absence of the detection target contained in the solution and the amount thereof. In this case, the procedure (1) becomes unnecessary.

Next, examples of the present invention will be explained.

### FIRST EXAMPLE

Using a thermal imprinting technique, a pillar-like pattern formed on a nickel die was transferred to a cyclic-olefin-based resin film (made by ZEON Corporation, product name: ZEONOR Film ZF-16, and thickness: 100 μm) with a glass transition temperature (Tg) of 163° C., and an optical sensor A was produced which had a plurality of concavo-convex structures including holes with a diameter of substantially 250 nm and a depth of 150 nm and arranged at a pitch of 500 nm.

Thermal imprinting was carried out through the following procedures. First, the nickel die heated to a temperature of 205° C. beforehand was pressed against the resin film at a pressure of 2 MPa for 180 seconds. Next, the nickel die and the resin film were cooled to a temperature of 100° C., the nickel die was demolded from the resin film, and a concavo-convex structure with holes was formed. An imprinting device (VX) made by SCIVAX Corporation was used for the thermal imprinting.

Next, using the optical sensor A, it was attempted to detect adsorption of proteins with different concentrations.

The protein was human Chorionic Gonadotropin (hCG) that is a hormone produced during a pregnancy, and it was adjusted to be a concentration of 1 pg/ml, 10 pg/ml, and 100 pg/ml, respectively, using ultrapure water. Next, respective solutions were dripped on the optical sensor A, and were left still for five minutes at a room temperature, so that human chorionic gonadotropin was physically adsorbed on the concavo-convex structure 2. After the sensor was left still, it was rinsed by ultrapure water in order to eliminate excessive hCG, and the optical characteristic was evaluated after the sensor was dried.

Regarding evaluation of the optical characteristic, white light from a tungsten-halogen light source (Ocean Optics, LS-1) was vertically emitted to the concavo-convex structure 2 of the optical sensor A through a multi-channel fiber (Ocean Optics, r200-7UV/VIS), and reflected light was detected by a multi-channel spectroscope (Ocean Optics, USB4000). Evaluation of the optical characteristic was carried out within a range in which the wavelength was from 350 nm to 1000 nm.

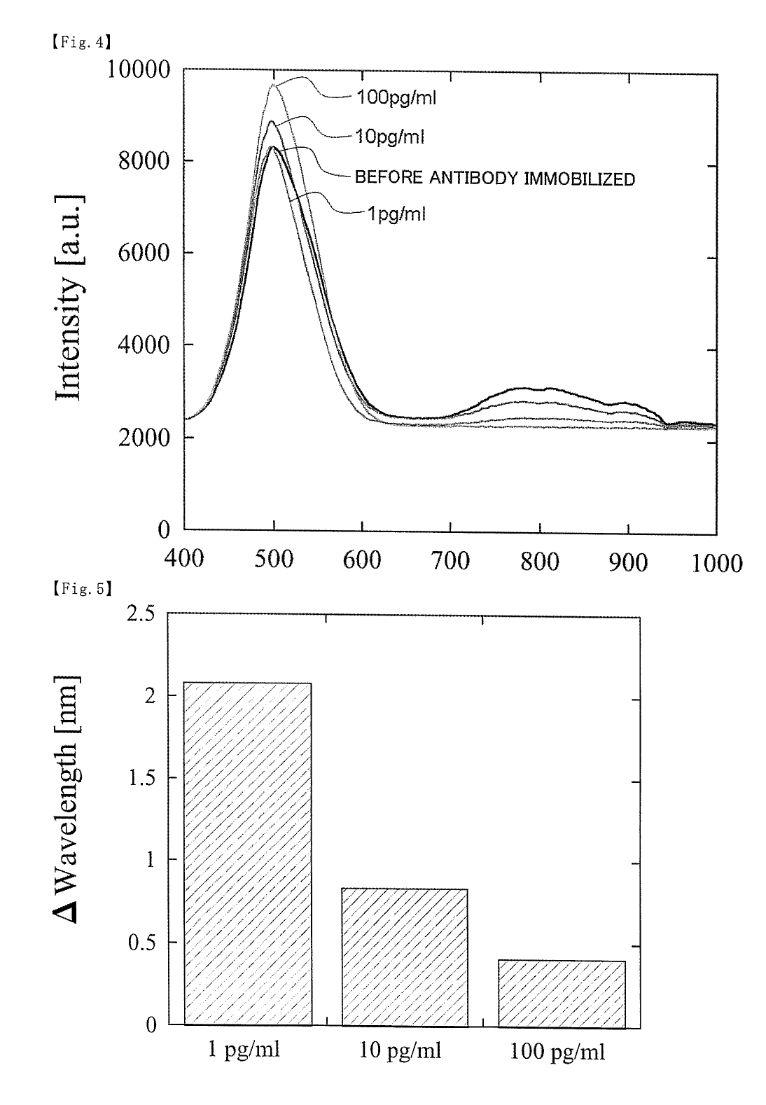

FIG. 4 shows optical characteristics before and after protein was adsorbed. Moreover, FIG. 5 shows a change in the peak wavelength of reflected light relative to the concentration of the protein, and FIG. 6 shows a change in the intensity.

As a result, a peak shift was observed (see FIG. 5) when the concentration of protein was 1 pg/ml, and the intensity increase was observed (see FIG. 6) when the concentrations were 10 pg/ml and 100 pg/ml.

### SECOND EXAMPLE

Using a thermal imprinting technique, a pillar-like pattern formed on a nickel die was transferred to cyclic-olefin-based resins (made by ZEON Corporation, product name: ZEONOR Film ZF-16, and thickness: 100 μm) with a glass transition temperature (Tg) of 163° C., and a film B which had a plurality of concavo-convex structures including holes with a diameter of substantially 100 nm and a depth of 150 nm and arranged at a pitch of 200 nm, and a film C which had a plurality of concavo-convex structures including holes with a diameter of substantially 250 nm and a depth of 150 nm and arranged at a pitch of 500 nm were produced.

Thermal imprinting was carried out through the following procedures. First, the nickel die heated to a temperature of 205° C. beforehand was pressed against the resin film at a pressure of 2 MPa for 180 seconds. Next, the nickel die and the resin film were cooled to a temperature of 100° C., the nickel die was demolded from the resin film, and a concavo-convex structure with holes was formed. An imprinting device (VX) made by SCIVAX Corporation was used for the thermal imprinting.

Next, metal layers each formed of gold (Au) and having a thickness of substantially 30 nm were formed on the surfaces of respective concavo-convex structures of the film B and the film C through vacuum deposition.

The vacuum deposition was carried out by depositing gold (Au) at a vacuum degree of equal to or smaller than 1.0×10⁻³ Pa and at a deposition speed of equal to or faster than 1.0 angstrom.

Next, antibodies (adsorption elements) that adsorb Human fibrinogen (detection target) were immobilized on respective metal layer surfaces of the film B and the film C, thereby producing an optical sensor B and an optical sensor C.

The antibodies were immobilized as follows. First, self-assembled monolayers were formed on respective surfaces of the film B and the film C using DDA (4,4′ODithiodibutylic acid) and a carboxyl group (—COOH) was introduced. Next, an NHS group was introduced using 400-mM WSC (Water Soluble carbodiimide)/100-mM mixed liquid. An antibody solution prepared using PBS (Phosphate buffered saline, pH 7.4) was added thereto per 100 mg/ml, thereby immobilizing the antibody. Finally, 1 M of Ethanol amine solution was added in order to block unreacted NHS group.

Next, using the optical sensors B and C, detection of adsorption of Human fibrinogen with different concentrations was attempted. Regarding adsorption of the Human fibrinogen, Human fibrinogen solutions adjusted to concentrations of 1 fg/ml, 1 pg/ml, 1 ng/ml, 1 n/ml, and 1 mg/ml were dripped to the optical sensors B and C, and the sensors were left still for 10 minutes at a room temperature, and were adsorbed on the antibodies (the adsorption elements) on respective concavo-convex structures. After the sensors were left still, those were rinsed by ultrapure water in order to eliminate excessive Human fibrinogen, and the optical characteristic was evaluated after the sensors were dried.

Regarding evaluation of the optical characteristic, white light from a tungsten-halogen light source (Ocean Optics, LS-1) was vertically emitted to respective concavo-convex structures 2 of the optical sensors B and C through a multi-channel fiber (Ocean Optics, r200-7UVNIS), and transmitted light was detected by a multi-channel spectroscope (Ocean Optics, USB4000).

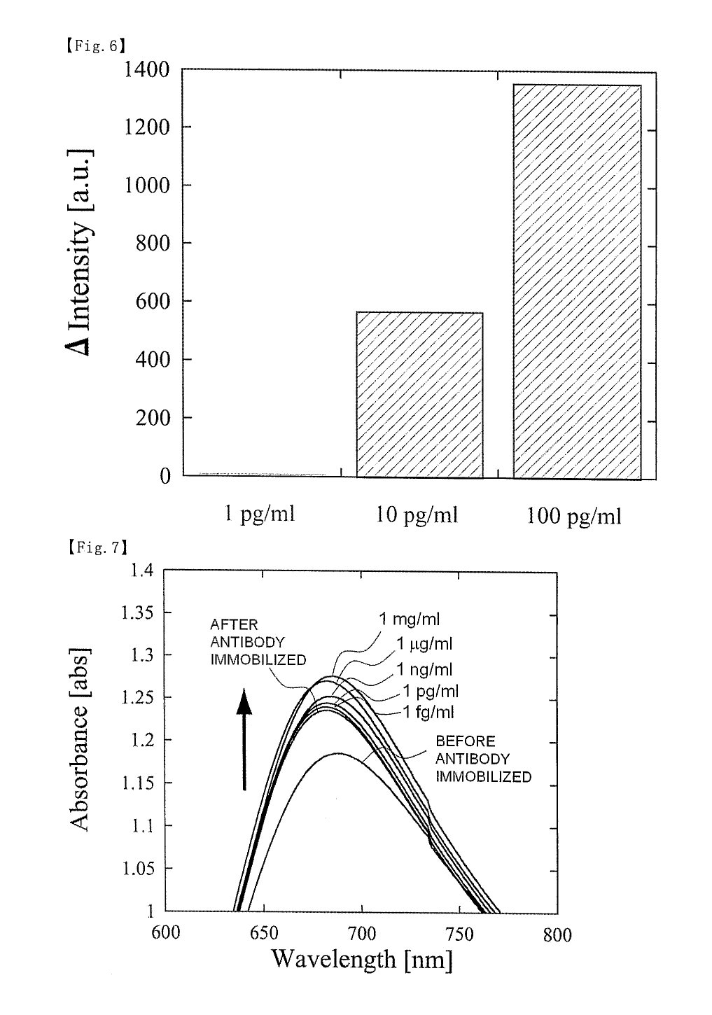

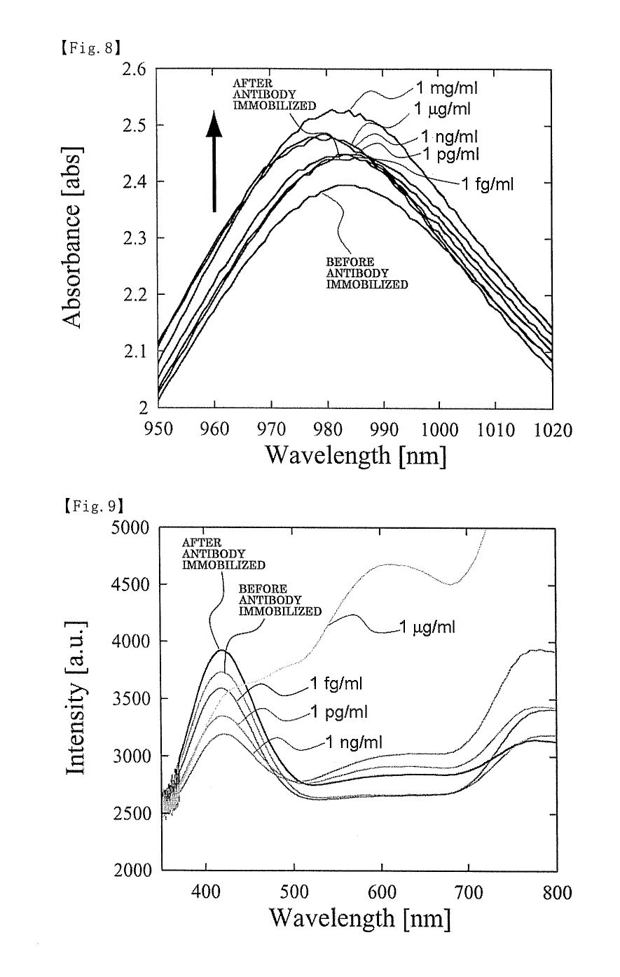

FIG. 7 shows an optical characteristic before and after the Human fibrinogen was adsorbed on the optical sensor B, and FIG. 8 shows an optical characteristic before and after the Human fibrinogen was adsorbed on the optical sensor C.

As a result, the light absorption level changed in the cases of both optical sensors B and C in accordance with the concentration of the Human fibrinogen. Moreover, a change in the light absorption level was observed in a range where the concentration of the Human fibrinogen was equal to or less than 1 pg/ml.

### THIRD EXAMPLE

Using a thermal imprinting technique, a pillar-like pattern formed on a nickel die was transferred to a cyclic-olefin-based resin film (made by ZEON Corporation, product name: ZEONOR Film ZF-16, and thickness: 100 μm) with a glass transition temperature (Tg) of 163° C., and a film D was produced which had a plurality of concavo-convex structures including holes with a diameter of substantially 200 nm and a depth of 150 nm and arranged at a pitch of 200 nm.

Thermal imprinting was carried out through the following procedures. First, the nickel die heated to a temperature of 205° C. beforehand was pressed against the resin film at a pressure of 2 MPa for 180 seconds. Next, the nickel die and the resin film were cooled to a temperature of 100° C., the nickel die was demolded from the resin film, and a concavo-convex structure with holes was formed. An imprinting device (VX) made by SCIVAX Corporation was used for the thermal imprinting.

Next, an antibody (the adsorption element) that adsorbs Human fibrinogen (the detection target) was immobilized on the surface of the concavo-convex structure of the film D, thereby producing an optical sensor D.

The antibody was immobilized as follows. First, it was soaked in an Anti-human fibrinogen antibody solution (10 μg/ml) and left still for one hour, and the antibody was immobilized on the concavo-convex structure by a hydrophobic mutual action. It was rinsed by ultrapure water, and dried.

Next, using the optical sensor D, detection of adsorption of Human fibrinogen with different concentrations was attempted. Regarding adsorption of the Human fibrinogen, Human fibrinogen solutions adjusted to concentrations of 1 fg/ml, 1 pg/ml, 1 ng/ml, and 1 μg/ml with a phosphate buffering solution (20 mM, pH 7.4) were prepared, and the optical sensor D was soaked in such liquids for one hour. The sensor was rinsed by ultrapure water in order to eliminate excessive Human fibrinogen, and the optical characteristic was evaluated after the sensor was dried.

Regarding evaluation of the optical characteristic, white light from a tungsten-halogen light source (Ocean Optics, LS-1) was vertically emitted to the concavo-convex structure 2 of the optical sensor D through a multi-channel fiber (Ocean Optics, r200-7UVNIS), and transmitted light was detected by a multi-channel spectroscope (Ocean Optics, USB4000).

FIG. 9 shows an optical characteristic before and after the Human fibrinogen was adsorbed on the optical sensor D.

As a result, the optical sensor D had a light absorption level changed in accordance with the concentration of the Human fibrinogen. Moreover, a change in the light absorption level was observed in a range where the concentration of the Human fibrinogen was equal to or less than 1 pg/ml.

Based on the foregoing results, it is proved that the optical sensor of the present invention can perform detection easily and highly sensitively under a condition in which a concentration is small like 1 pg/ml which makes analysis difficult according to the conventional analyzing techniques or needs a large and expensive analyzing apparatus.

1. An optical sensor that detects a predetermined detection target, the optical sensor comprising:
a concavo-convex structure which has a predetermined form periodically arranged in a two-dimensional manner and which functions as a photonic crystal; and
a metal layer which is formed on a surface of the concavo-convex structure and which is capable of exciting localized surface plasmon resonance

2. The optical sensor according to claim 1, wherein a difference between a peak wavelength of light reflected by the concavo-convex structure and a peak wavelength of light absorbed by the metal layer is equal to or smaller than 10 nm.

3. The optical sensor according to claim 1, wherein the concavo-convex structure includes columns or holes each having a certain diameter within a range from 50 to 500 nm and periodically arranged at a certain pitch within a range from 50 to 1000 nm in a two-dimensional manner.

4. The optical sensor according to claim 1, wherein a film thickness of the metal layer is 5 to 200 nm.

5. The optical sensor according to claim 1, wherein the metal layer includes an adsorption element that adsorbs the detection target on a surface thereof.

6. The optical sensor according to claim 1, wherein the concavo-convex structure is formed of any one of a cyclic-olefin-based resin, an acrylic resin, polycarbonate, a vinyl-ether resin, a fluorine resin, and a polyester-based resin.

7. An optical sensor that detects a predetermined detection target, the optical sensor comprising:
a concavo-convex structure which includes a predetermined form periodically arranged in a two-dimensional manner and which functions as a photonic crystal, wherein the concavo-convex structure is formed of any one of resins selected from a following group:
a cyclic-olefin-based resin; an acrylic resin;
polycarbonate;
a vinyl-ether resin;
a fluorine resin; and
a polyester-based resin.

8. The optical sensor according to claim 7, wherein the concavo-convex structure is formed by imprinting.

9. The optical sensor according to claim 7, wherein the concavo-convex structure is formed of a material dissolved or decomposed by the detection target.

10. The optical sensor according to claim 9, wherein the metal layer is formed of a material dissolved or decomposed by the detection target.

11. The optical sensor according to claim 8, wherein the concavo-convex structure includes an adsorption element that adsorbs the detection target on a surface thereof.

12. A method for manufacturing an optical sensor that detects a predetermined detection target, the method comprising:
a concavo-convex structure forming step of forming a concavo-convex structure which has a predetermined form periodically arranged in a two-dimensional manner and which functions as a photonic crystal; and
a metal layer forming step of forming a metal layer on a surface of the concavo-convex structure, the metal layer being capable of exciting localized surface plasmon resonance.

13. The optical sensor manufacturing method according to claim 12, wherein in the concavo-convex structure forming step, the concavo-convex structure is formed by imprinting.

14. The optical sensor manufacturing method according to claim 12, wherein in the metal layer forming step, the metal layer is formed by any one of physical vapor deposition (PVD), chemical vapor deposition (CVD), and plating.

15. A detection method for detecting a detection target contained in a sample solution, the method comprising:
preparing an optical sensor which includes a concavo-convex structure that functions as a photonic crystal and a metal layer formed on a surface of the concavo-convex structure and being capable of exciting localized surface plasmon resonance, the optical sensor having a difference of equal to or smaller than 10 nm between a peak wavelength of light reflected by the concavo-convex structure and a peak wavelength of light absorbed by the metal layer; and
comparing a characteristic of light reflected by the optical sensor with a characteristic of light reflected by the optical sensor after the sample is caused to contact the concavo-convex structure, thereby detecting the detection target contained in the sample solution.

16. A detection method for detecting a detection target contained in a sample solution, the method comprising:
preparing an optical sensor which includes a concavo-convex structure that functions as a photonic crystal and a metal layer formed on a surface of the concavo-convex structure and being capable of exciting localized surface plasmon resonance, the optical sensor having a difference of equal to or smaller than 10 nm between a peak wavelength of light reflected by the concavo-convex structure and a peak wavelength of light absorbed by the metal layer;
preparing a database built by causing samples containing the detection target with various concentrations to contact the optical sensor, and by detecting respective characteristics of light reflected by the optical sensor; and
comparing a characteristic of light reflected by the optical sensor after the sample solution is caused to contact the concavo-convex structure with information stored in the database, thereby detecting the detection target contained in the sample solution.

17. An optical sensor that detects a predetermined detection target, the optical sensor comprising:
a concavo-convex structure which has a predetermined form periodically arranged in two-dimensional manner and which functions as a photonic crystal; and
the concavo-convex structure is formed of a material dissolved or decomposed by the detection target.
